(19) United States
(12) Patent Application Publication
(10) Pub. No.: US 2017/0346601 A1
(43) Pub. Date: Nov. 30, 2017

(54) DATA TRANSMISSION METHOD AND COMPUTING APPARATUS HAVING DATA TRANSMISSION FUNCTION

(71) Applicant: SAMSUNG SDS CO., LTD., Seoul (KR)

(72) Inventors: Kyu Sang LEE, Seoul (KR); Eil Woo BAIK, Seoul (KR); Ki Woon SUNG, Seoul (KR); Jae Seok LEE, Seoul (KR)

(73) Assignee: SAMSUNG SDS CO., LTD., Seoul (KR)

(21) Appl. No.: 15/608,147

(22) Filed: May 30, 2017

(30) Foreign Application Priority Data
May 30, 2016 (KR) 10-2016-0066508

(51) Int. Cl. H04L 1/18; H04L 12/18; H04L 12/841; H04L 12/801; H04W 80/06

(52) U.S. Cl. CPC H04L 1/189; H04L 12/1868; H04L 47/28; H04L 1/1867; H04W 80/06; H04L 47/14

(57) ABSTRACT

Provided are a data transmission method, the method comprises transmitting data from a data transmission apparatus to a data reception apparatus, selecting time difference retransmission target data from the data according to a preset rule by using the data transmission apparatus, determining a retransmission time interval according to characteristics of the time difference retransmission target data by using the data transmission apparatus, determining whether time difference retransmission is possible based on the state of a network when the retransmission time interval arrives by using the data transmission apparatus and retransmitting the time difference retransmission target data to the data reception apparatus when determining that the time difference retransmission is possible by using the data transmission apparatus.

This application claims the benefit of Korean Patent Application No. 10-2016-0066508, filed on May 30, 2016, in the Korean Intellectual Property Office, the disclosure of which is incorporated herein by reference in its entirety.

### BACKGROUND

### 1. Field

The present inventive concept relates to a data transmission method and apparatus, and more particularly, to a data transmission method and apparatus which prevent transmission delay and deterioration of service quality due to packet loss during transmission of data to a data reception apparatus.

### 2. Description of the Related Art

The provision of various services through the Internet protocol (IP) network has a disadvantage in that it cannot guarantee a certain level of service quality despite the advantage of maximizing transmission efficiency. This problem is caused by best effort which is an intrinsic characteristic of IP service. Therefore, it is not easy to fundamentally solve the problem as long as a service is provided through the IP network.

A service such as web or file transfer is a data-oriented service that is not sensitive to the time of delivery. Therefore, service quality is not considered to be a big program. However, in real-time services based on video data, voice data and real-time control data sensitive to the time of delivery, such as a video on demand (VOD) service, a voice over IP (VoIP) service, an online game service and a video call system, maintaining more than a certain level of service quality is a very important issue.

In order to maintain the quality of service at a certain level, it is important to guarantee a transmission delay time within a predetermined period of time even when a data error or loss occurs during transmission.

To this end, conventional techniques have been developed based on a forward error correction (FEC) technique. This is because as a round trip time (RTT) becomes larger, it is difficult to guarantee a transmission delay within a predetermined period of time using error correction techniques based on automatic repeat request (ARQ).

However, the conventional techniques based on the FEC technique have the following problems because their main purpose is to detect errors and recover data at the receiving end. First, the computation cost for error recovery is large. Second, the conventional techniques are difficult to be widely used because additional logic is required for error detection and recovery at the receiving end. Third, when errors occur intensively in one section, even if the errors are detected, they are not likely to be corrected. Thus, the conventional techniques are vulnerable to a burst error.

In this regard, there is a need for a data transmission method that is invulnerable to a burst error and guarantees a transmission delay time within a predetermined period of time while not requiring additional logic at the receiving end.

### SUMMARY

Aspects of the inventive concept provide a data transmission method and apparatus which guarantee a transmission delay time within a predetermined period of time regardless of a round trip time (RTT) by performing time difference retransmission for avoiding a packet loss section at the transmitting end.

Aspects of the inventive concept also provide a data transmission method and apparatus which efficiently utilize network bandwidth by selecting time difference retransmission target data and performing time difference retransmission only for the selected data.

Aspects of the inventive concept also provide a data transmission method and apparatus which determine an optimum retransmission time interval for avoiding a packet loss section by determining the retransmission time interval according to characteristics of data and a jitter buffer value of the receiving side.

Aspects of the inventive concept also provide a data transmission method and apparatus which can guarantee a transmission delay time within a predetermined period of time and prevent network congestion due to retransmission by determining whether time difference retransmission is possible and adjusting throughput according to available bandwidth of a network.

Aspects of the inventive concept also provide a data transmission method and apparatus which can be widely used because they guarantee a transmission delay time within a predetermined period of time using logic of the transmitting end without requesting the receiving end for logic.

However, aspects of the inventive concept are not restricted to the one set forth herein. The above and other aspects of the inventive concept will become more apparent to one of ordinary skill in the art to which the inventive concept pertains by referencing the detailed description of the inventive concept given below.

According to an aspect of the inventive concept, there is provided a data transmission method comprising transmitting data from a data transmission apparatus to a data reception apparatus, selecting time difference retransmission target data from the data according to a preset rule by using the data transmission apparatus, determining a retransmission time interval according to characteristics of the time difference retransmission target data by using the data transmission apparatus, determining whether time difference retransmission is possible based on the state of a network when the retransmission time interval arrives by using the data transmission apparatus and retransmitting the time difference retransmission target data to the data reception apparatus when determining that the time difference retransmission is possible by using the data transmission apparatus.

According to another aspect of the inventive concept, there is provided a data transmission apparatus comprising one or more processors, a network interface configured to transmit and receive data to and from a data reception apparatus, a memory configured to load a computer program to be executed by the processors and a storage configured to store the computer program, wherein the computer program comprises instructions to perform a method comprising an operation of transmitting data to the data reception apparatus, an operation of selecting time difference retransmission target data from the data according to a preset rule, an operation of determining a retransmission time interval according to characteristics of the time difference retransmission target data, an operation of determining whether time difference retransmission is possible based on the state of a network when the retransmission time interval arrives and an operation of retransmitting the time difference retransmission target data to the data reception apparatus when determining that the time difference retransmission is possible.

According to another aspect of the inventive concept, there is provided a non-transitory computer-readable medium containing instructions which, when executed by a computing device, cause the computing device to perform the steps of transmitting data to a data reception apparatus, selecting time difference retransmission target data from the data according to a preset rule, determining a retransmission time interval according to characteristics of the time difference retransmission target data, determining whether time difference retransmission is possible based on the state of a network when the retransmission time interval arrives and retransmitting the time difference retransmission target data to the data reception apparatus when determining that the time difference retransmission is possible.

### BRIEF DESCRIPTION OF THE DRAWINGS

These and/or other aspects will become apparent and more readily appreciated from the following description of the embodiments, taken in conjunction with the accompanying drawings in which:

FIG. 1 is a diagram for explaining best effort which is a general characteristic of an Internet protocol (IP) network;

FIGS. 2A and 2B are diagrams for explaining problems of a conventional automatic repeat request (ARQ) technique due to a round-trip time (RTT);

FIG. 3 is a diagram for explaining problems of a conventional forward error correction (FEC) technique due to a burst error;

FIGS. 4A and 4B are diagrams for explaining the concept and effect of time difference retransmission referred to in some embodiments;

FIG. 5 is a flowchart illustrating a data transmission method according to an embodiment;

FIG. 6 is a flowchart illustrating a data transmission method according to an embodiment;

FIGS. 7A and 7B are detailed flowcharts illustrating a method of determining whether time difference retransmission is necessary in FIG. 6;

FIGS. 8A and 8B are detailed flowcharts illustrating a method of determining a retransmission time interval in data transmission methods according to embodiments;

FIGS. 9A, 9B and 9C are detailed flowcharts illustrating a method of securing a delay margin time in data transmission method according to embodiments;

FIG. 10 is a detailed flowchart illustrating a method of determining whether time difference retransmission is possible in data transmission methods according to embodiments;

FIG. 11 is a functional block diagram of a data transmission apparatus according to an embodiment;

FIG. 12 is a hardware block diagram of a data transmission apparatus according to an embodiment;

FIG. 13 is a diagram for explaining an example method of selecting time difference retransmission target data in a video call system according to an embodiment;

FIG. 14A illustrates the results of measuring a mean opinion score (MOS) according to a packet loss rate in a video call system according to an embodiment;

FIG. 14B illustrates the results of measuring siding sumset entropy (SSE) according to a packet loss rate in a video call system according to an embodiment; and

FIG. 14C illustrates a speech waveform at the receiving end of a video call system according to an embodiment when a packet loss rate is 35%.

### DETAILED DESCRIPTION

Hereinafter, preferred embodiments of the present invention will be described with reference to the attached drawings. Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like numbers refer to like elements throughout.

Unless otherwise defined, all terms including technical and scientific terms used herein have the same meaning as commonly understood by one of ordinary skill in the art to which this invention belongs. Further, it will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. The terms used herein are for the purpose of describing particular embodiments only and is not intended to be limiting. As used herein, the singular forms are intended to include the plural forms as well, unless the context clearly indicates otherwise.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Hereinafter, the inventive concept will be described in greater detail with reference to the accompanying drawings.

### Problems of the Conventional Art

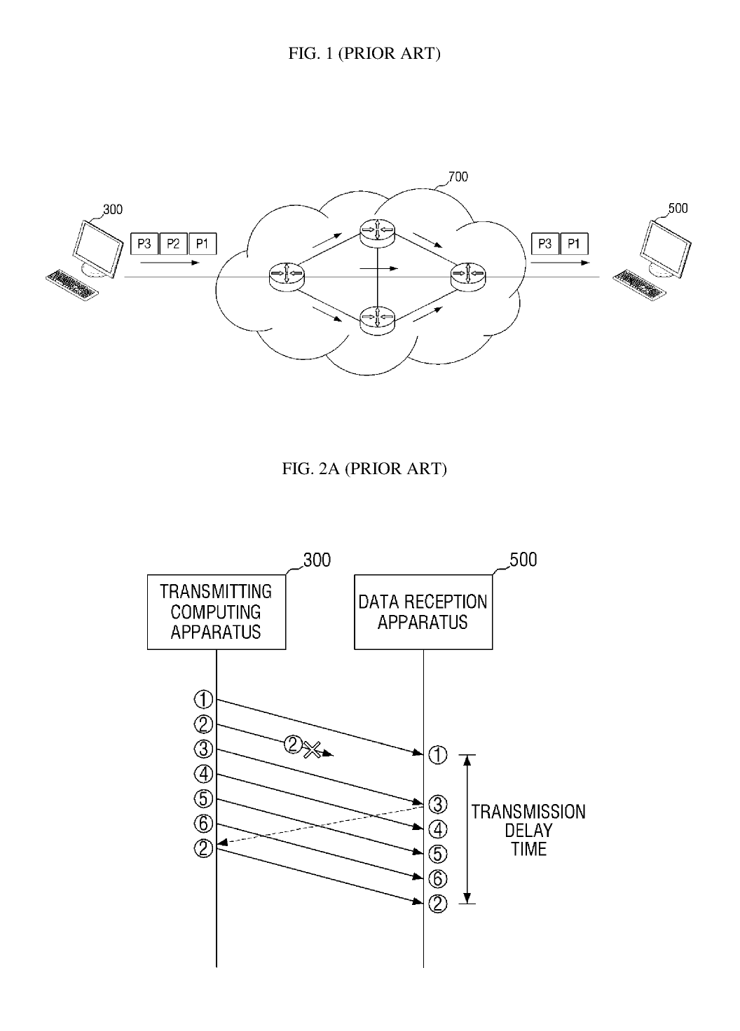

FIG. 1 is a diagram for explaining best effort which is a general characteristic of an Internet protocol (IP) network.

Various remote computing apparatuses 300 and 500 connected to an IP network can transmit and receive data to and from each other via the IP network. Since the IP network uses a packet switching method, data transmitted through the IP network is divided into small packets at the network level, and the packets are transmitted to a data reception apparatus independently of each other.

The IP network uses the packet switching method. in order to maximize the transmission efficiency and increase the reliability of the network itself. Specifically, in the packet switching method, a particular computing apparatus does not occupy the bandwidth of the network, as in a circuit switching method, regardless of whether the network is used or not. Therefore, the packet switching method allows a plurality of computing apparatuses to use the bandwidth of the network more efficiently. In addition, since data is divided into smaller packets and transmitted accordingly in the packet switching method, the probability of error occurrence during transmission is reduced. If there is an error in a specific path on the network, a network apparatus can transmit a corresponding packet to another path. Therefore, the reliability of the network itself is increased.

However, since the IP network does not provide a recovery function for packet loss and corruption, the delivery of a packet to the data reception apparatus is not guaranteed. That is, the IP network makes its best effort to deliver a packet but does not guarantee reliable delivery. This characteristic of the IP network is called “no guarantee” or “best effort.”

Referring to FIG. 1, transmitting computing apparatus 300 transmits data to a data reception apparatus 500 via an IP network 700. The data transmitted from the transmitting computing apparatus 300 is divided into three packets at the network level and transmitted accordingly. However, it can be seen that only two packets are transmitted to the data reception apparatus 500 due to the best effort characteristic of the IP network. Packet loss can occur due to various reasons such as network congestion and abnormal physical conditions of the network. Therefore, a technique for solving the packet loss problem is needed in order to provide a service of a certain quality or more in the IP network.

Conventional techniques for solving the packet loss problem mainly rely on an error correction technique. The error correction technique can be classified into an automatic repeat request (ARQ) technique and a forward error correction (FEC) technique. Hereinafter, problems of the conventional error correction technique will be described.

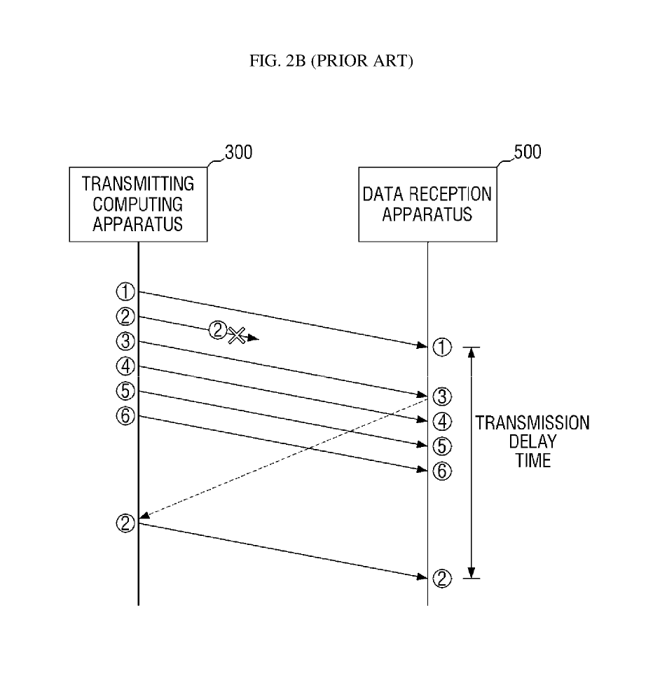

FIGS. 2A and 2B are diagrams for explaining problems of the conventional ARQ technique due to a round-trip time (RTT).

Referring to FIGS. 2A and 2B, a transmitting computing apparatus 300 transmits a total of six packets to a data reception apparatus 500, and a distance between the transmitting computing apparatus 300 and the data reception apparatus 500 denotes a data transmission time between the two apparatuses. Therefore, it can be seen that an RTT between the transmitting computing apparatus 300 and the data reception apparatus 500 illustrated in FIG. 2B is greater than an RTT between the transmitting computing apparatus 300 and the data reception apparatus 500 illustrated in FIG. 2A. For reference, the RTT refers to a packet round-trip time between two apparatuses. The RTT can be varied for various reasons such as a bottleneck of a specific section on a network path and existence of a wireless section as well as a difference between physical locations of the two apparatuses.

Although the transmitting computing apparatus 300 transmitted a total of six packets, it can be seen that a packet 2 has been lost in the course of transmission. The data reception apparatus 500 may identify that the packet 2 has been lost at the time of receiving a packet 3 and request the transmitting computing apparatus 300 to retransmit the packet 2. The transmitting computing apparatus 300 receiving the retransmission request may retransmit the packet 2. If the retransmitted packet 2 is also lost, the computing apparatus 300 may retransmit the packet 2 according to a retransmission timeout,

Comparing FIGS. 2A and 2B, it can be seen that a transmission delay time due to the loss of the packet 2 is much greater in FIG. 213 than in FIG. 2A. The transmission delay time refers to the time taken from the transmission of a packet to the reception of the packet. The difference in transmission delay time occurs because the ARQ technique requires a transmission delay time of at least the RTT or more. Specifically, the ARQ technique always requires a period of time equal to or greater than the RTT because it includes at least a request time for a lost packet and a retransmission time for the losted packet which is a response to the request. Therefore, if the RTT is small, a transmission delay may not be a big problem. However, as the RTT increases, the transmission delay time within a predetermined period of time cannot be guaranteed, which can be a problem.

In particular, in the case of a service dealing with real-time data, guaranteeing a transmission delay within a predetermined period of time is an important issue directly related to service quality. For example, in a voice call service such as voice over Internet protocol (VoIP), if a transmission delay within a predetermined period of time is not guaranteed, the quality of service is significantly degraded because voice is frequently disconnected. Therefore, due to the restrictions of the RTT, it is difficult to apply the conventional ARQ technique to a service that requires a guarantee of a transmission delay within a predetermined period of time.

In the present specification, real-time data refers to data which is greatly affected by the time of delivery and whose value is lost if the data is not transmitted within a predetermined period of time. Examples of the real-time data may include voice data and video data transmitted and received in a video call system, data reflecting real-time status information of various sensors constituting the Internet of things (IoT), and control data for remote control of a drone.

It should be noted that the real-time data can be used in other forms of terms such as time critical data and time sensitive data by those of ordinary skill in the art, but all these terms refer to the same object.

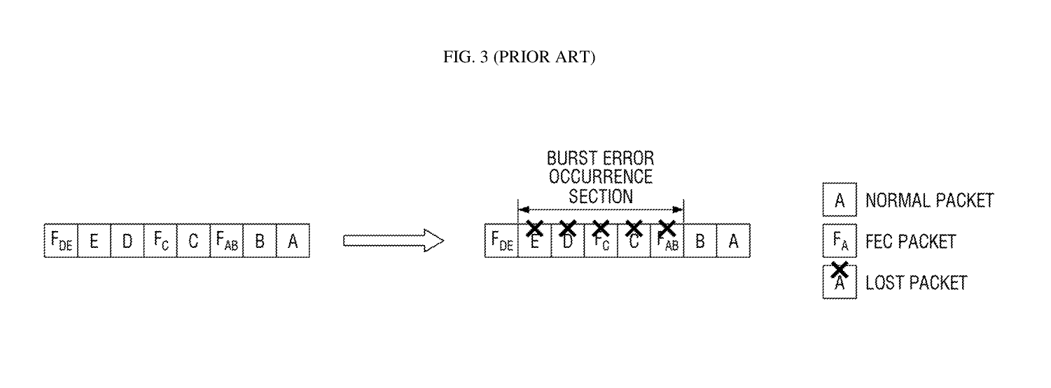

Next, problems of the FEC technique due to a burst error will be described with reference to FIG. 3.

To solve the problems of the ARQ technique described above, the FEC technique can be used. The FEC technique is a technique for transmitting additional data for error detection and correction when transmitting original data and detecting and correcting errors using the additional data in a receiving computing apparatus. That is, in the FEC technique, unlike in the ARQ technique, even if an error is found, the problem is solved at the receiving end without a request for retransmission. Thus, although the additional network cost and the computing cost of a computing apparatus are consumed, a transmission delay due to retransmission can be reduced.

However, the error correction of the FEC technique is dependent on the characteristics of an error related to the location the error. Therefore, the FEC technique does not always guarantee the correction of the error. This is a problem that occurs because only minimum data for error detection and correction is added and transmitted to reduce the additional network cost. In particular, in the case of a burst error defined as an intensive error that occurs in a specific section, it is very difficult to correct the error using the FEC technique.

Referring to FIG. 3, transmission data illustrated on the left side includes five data packets A through E and error correction packets F_{AB}, F_{C} and F_{DE}. However, during the transmission process, the packets C through E and the packets F_{AB} and F_{C} are successively^{,} lost due to a burst error on the network. The burst error can occur for a variety of reasons such as network congestion, physical reasons of hardware, and the intervention of a wireless network.

In this situation, even if a data reception apparatus detects the lost packets, it is impossible to recover the packets C through E using the error correction packets F_{C} and F_{DE}. The packet C cannot be recovered because the error correction packet F_{C} has also been lost. The packet D and the packet E cannot be recovered because at least one or more data packets are generally required to recover a lost packet using the error correction packet F_{DE}. Therefore, the FEC technique may be particularly vulnerable to the burst error. In addition, the FEC technique cannot be widely used because the computing cost for restoration is high and because it is based on the premise that error detection and recovery techniques are required at the receiving end.

In summary, the conventional error correction technique is divided into the ARQ technique and the FEC technique. With the ARQ technique, it is difficult to guarantee a transmission delay within a predetermined period of time as the RTT increases. The FEC technique shows limitations because it is vulnerable to a burst error.

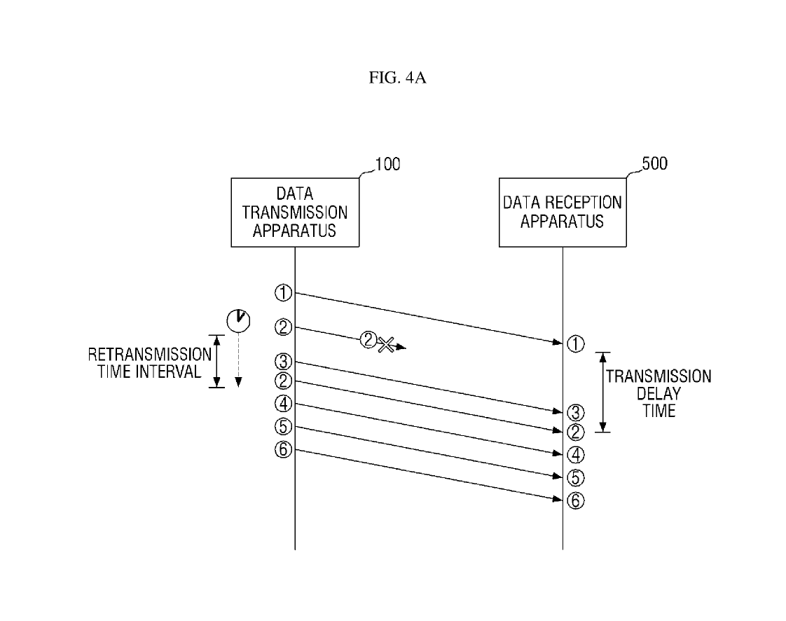

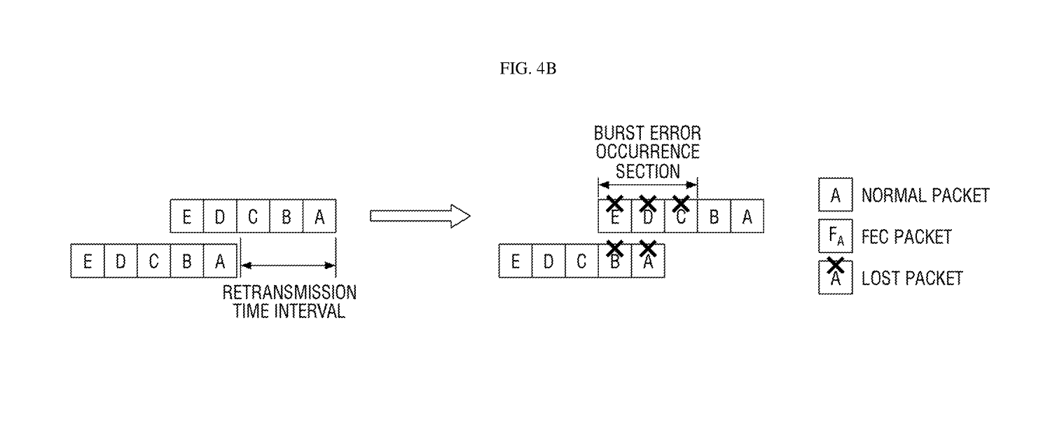

Hereinafter, the inventive concept for solving the problems of the conventional art will be described with reference to FIGS. 4 through 10.

### Concept of Time Difference Retransmission

FIGS. 4A and 4B are diagrams for explaining the concept and effect of time difference retransmission referred to in some embodiments.

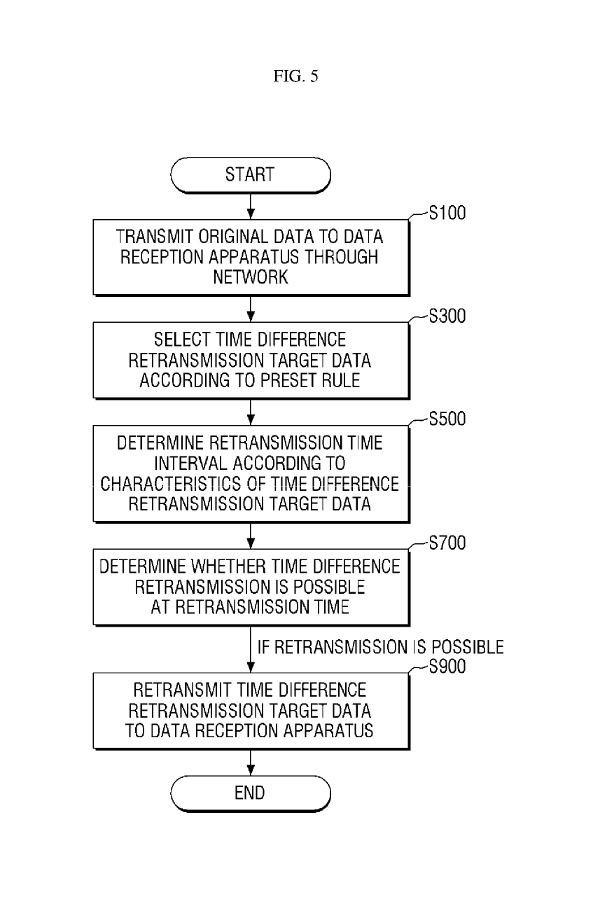

Unlike the conventional error correction technique, a data transmission method according to an embodiment, which will be described later with reference to FIG. 5, guarantees a transmission delay within a predetermined period of time using a packet loss section avoidance technique and uses the concept of time difference retransmission for avoiding a packet loss section.

Referring to FIG. 4A, as in FIG. 2B, a computing apparatus 100 (hereinafter, referred to as a ‘data transmission apparatus’) having a data transmission function according to the inventive concept transmits a total of six packets to a data reception apparatus 500, and an RTT between the data transmission apparatus 100 and the data reception apparatus 500 is relatively large.

The data transmission apparatus 100 may retransmit a packet after a predetermined retransmission time interval in case the packet is lost. The retransmission time interval refers to a time interval between the transmission of original data and the retransmission of the original data. The retransmission after the retransmission time interval is called “time difference retransmission” in order to make a distinction from the retransmission based on an ARQ.

Comparing FIGS. 4A and 2B, it can be seen that a transmission delay time of a lost packet 2 is significantly smaller in FIG. 4A than in FIG. 2B even when the RTT is relatively large. This difference stems from the fact that retransmission is performed actively without a request for retransmission in time difference retransmission according to the inventive concept, whereas retransmission is performed at the request of the data reception apparatus in the ARQ technique illustrated in FIG. 2B. Therefore, if the time difference retransmission concept is used, the transmission delay time can be effectively reduced even when the RTT is large.

Next, referring to FIG. 4B, the data transmission apparatus 100 transmits packets A through E to the data reception apparatus 500, and a burst error occurs as in FIG. 3.

Due to the burst error, successive packet losses occurred in a section of the packets C through E of original data and in a section of the packets A and B of data retransmitted with a time difference from the original data. However, of the lost packets of the original data, the packets C, D and E included in the data retransmitted with a time difference can be easily recovered by a buffer control technique that is typically implemented in the data reception apparatus.

More specifically, since the data retransmitted with a time difference is transmitted in the same sequence number as the original data, the data reception apparatus compares the two pieces of data stored in a reception buffer to check for the lost packets (C, D and E) of the original data and easily recovers the lost packets by checking whether the lost packets (C, D and E) are included in the retransmitted data.

Comparing FIG. 4B and FIG. 3, the inventive concept using the time difference retransmission concept enables data to be transmitted by avoiding a packet loss section. Therefore, unlike the FEC technique, the inventive concept is invulnerable to a burst error.

Until now, the concept and effect of the time difference retransmission according to the inventive concept have been described with reference to FIGS. 4A and 4B. In summary, the time difference retransmission concept is invulnerable to a burst error because it avoids a packet loss section and guarantees a transmission delay of a predetermined period of time or less regardless of the RTT. Hereinafter, a data transmission method according to an embodiment will be described in detail with reference to FIG. 5. For ease of understanding, it should be noted that the subject of each operation included in the data transmission method may be omitted.

### Data Transmission Method According to an Embodiment

FIG. 5 is a flowchart illustrating a data transmission method according to an embodiment.

Referring to FIG. 5, a data transmission apparatus transmits original data to a data reception apparatus through a network (operation S100). The data may include real-time data that must be transmitted to the data reception apparatus within a predetermined period of time.

After transmitting the original data, the data transmission apparatus may perform time difference retransmission for avoiding a packet loss section. However, retransmitting all data to guard against packet loss of some data is inefficient because it requires excessive network cost and may cause network congestion. Therefore, the data transmission apparatus to which the inventive concept is applied may perform selective time difference retransmission. To this end, the data transmission apparatus may select target data of the time difference retransmission according to a preset rule (operation S300). Details of a method of selecting the time difference retransmission target data will be described later.

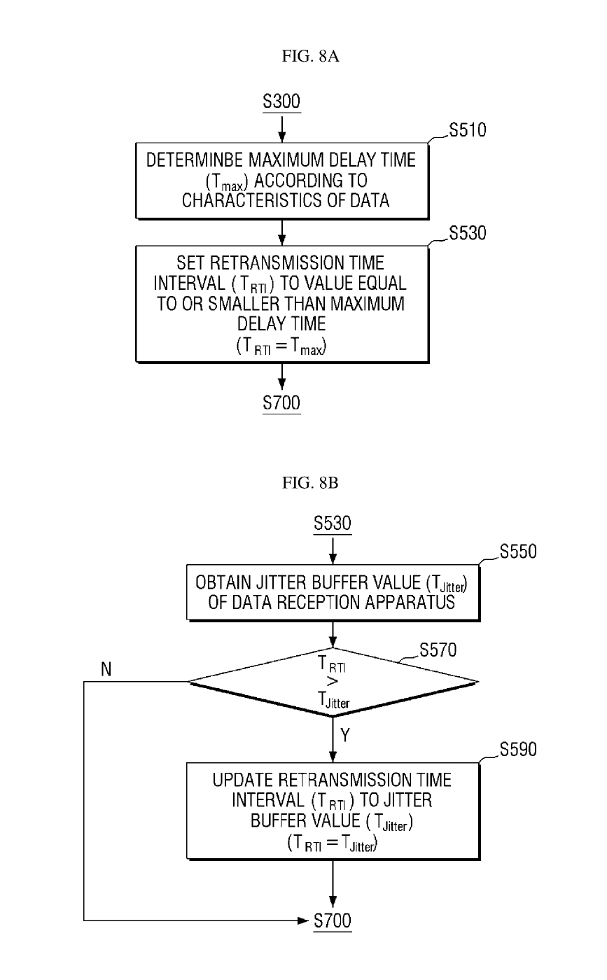

When the time difference retransmission target data is selected, the data transmission apparatus determines a retransmission time interval according to characteristics of the time difference retransmission target data (operation S500). Here, the data transmission apparatus does not immediately retransmit the data in order to maximize the effect of avoiding a packet loss section. However, in the case of real-time data that must be delivered within a predetermined period of time, the need to retransmit the real-time data disappears after the predetermined period of time. Therefore, it is necessary to determine the retransmission time interval that maximizes the effect of avoiding the packet loss section while preserving the value of the data. Details of a method of determining the retransmission time interval will be described later with reference to FIGS. 8A and 8B.

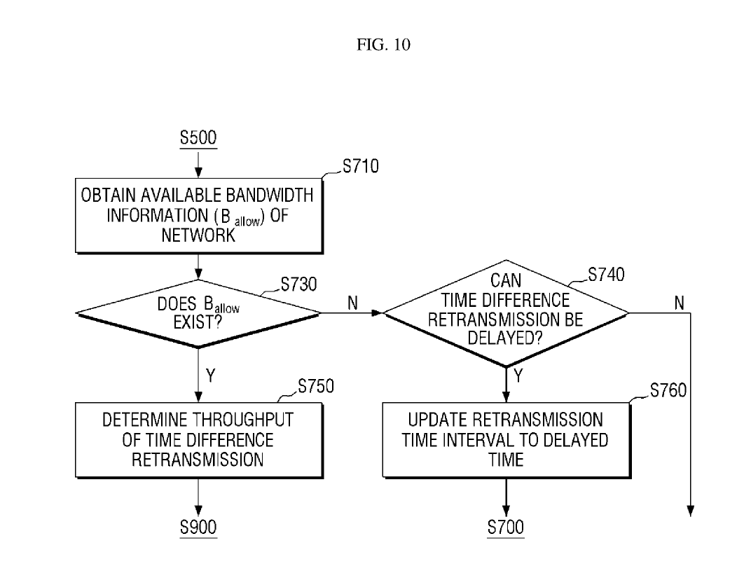

When the time to perform the time difference retransmission arrives after the retransmission time interval, the data transmission apparatus determines whether the time difference retransmission is possible before performing the time difference retransmission (operation S700). This is to prevent data transmitted additionally due to the time difference retransmission from causing congestion in the existing network. In addition, the effect of avoiding the packet loss section in the time difference retransmission is insignificant when packet loss is continued due to network congestion. For example, the data transmission apparatus may determine that the time difference retransmission is possible based on a state of network such as available bandwidth. Here, the fact that the time difference retransmission is possible based on the network state may mean that the probability that the time difference retransmission target data is transmitted to the destination (e.g. data reception apparatus) via the network is more than a certain value. Details of this operation will also be described later with reference to FIG. 10.

When determining that the time difference retransmission is possible, the data transmission apparatus retransmits the time difference retransmission target data to the data reception apparatus even without a retransmission request from the data reception apparatus (operation S900). That is, the retransmission is not performed in response to a retransmission request but is performed by the data transmission apparatus itself.

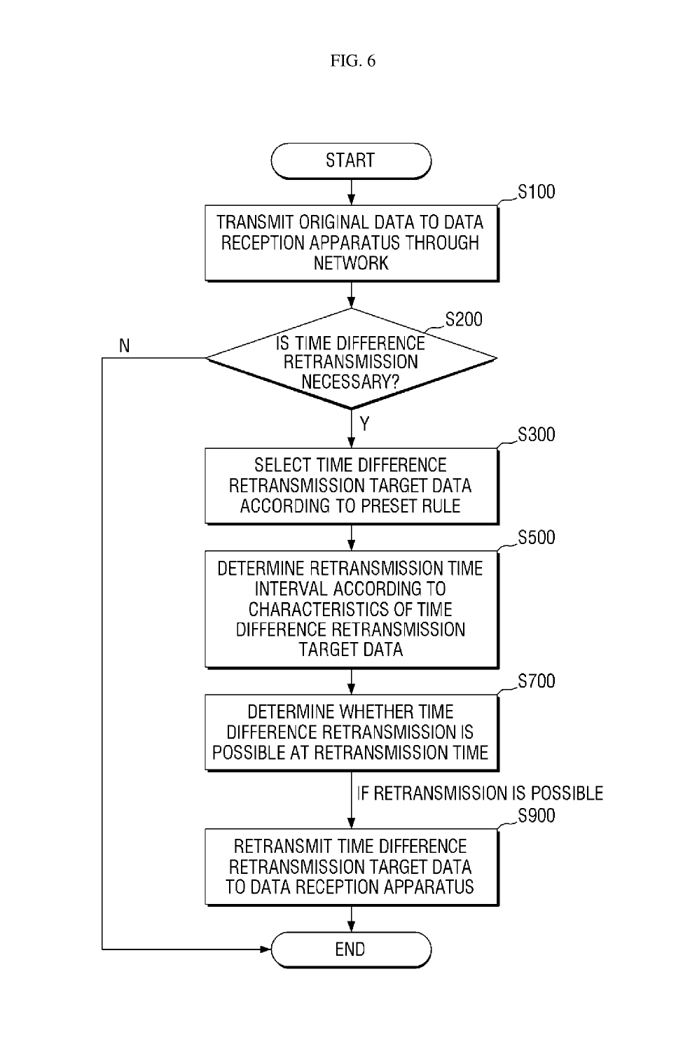

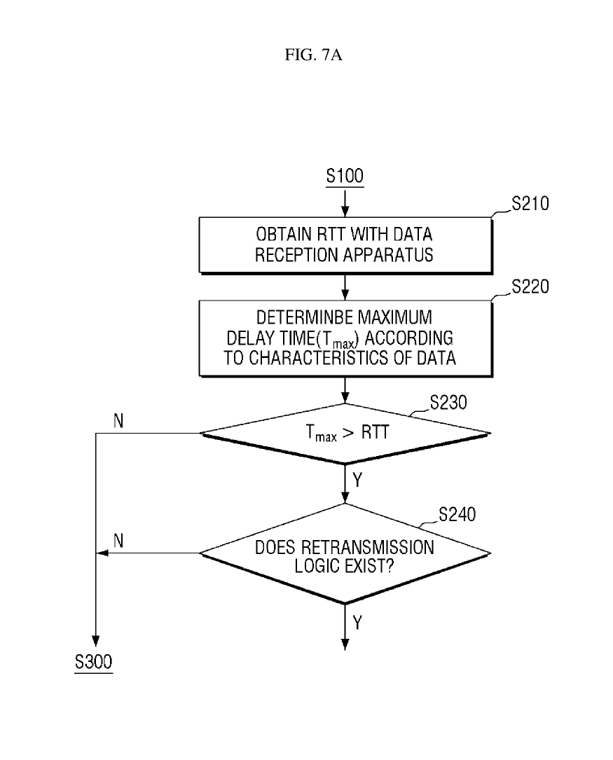

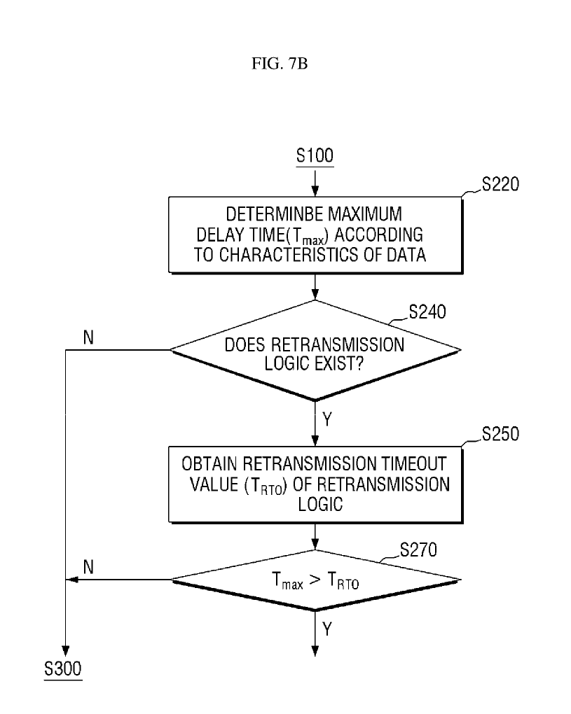

If an RTT is not large, a transmission delay within a predetermined period of time can be guaranteed through ARQ-based retransmission even if the time difference retransmission is not performed. If the transmission delay within the predetermined period of time is guaranteed, the ARQ technique can reduce the network cost because it performs retransmission only for lost data. Therefore, a data transmission method according to an embodiment may further include an operation of determining whether the time difference retransmission is necessary. Hereinafter, a data transmission method according to an embodiment will be described with reference to FIGS. 6 and 7.

### Data Transmission Method According to an Embodiment

Referring to FIG. 6, an operation (S200) of determining whether time difference retransmission is necessary is added. Accordingly, in the data transmission method according to the embodiment, a data transmission apparatus may select time difference retransmission target data only when determining that the time difference retransmission is necessary (operation S300), determine a retransmission time interval (operation S500), determine whether the tune difference retransmission is possible (operation S700), and perform the time difference retransmission (operation S900).

To determine whether the time difference transmission is necessary, an RTT between the data transmission apparatus and a data reception apparatus, the existence of ARQ-based retransmission logic, and a maximum delay time according to characteristics of data may be taken into consideration. Here, the maximum delay time denotes a maximum delay time that can be allowed by the receiving end to guarantee more than a certain level of service quality.

The RTT between the data transmission apparatus and the data reception apparatus and the existence of the ARQ-based retransmission logic are taken into consideration because the ARQ-based retransmission logic causes a transmission delay of about the RTT at the receiving end. Therefore, if the RTT is within the maximum delay time, a transmission delay within a predetermined period of time can be guaranteed even if the time difference retransmission is not performed.

Referring to FIG. 7A, in the operation (S200) of determining whether the time difference retransmission is necessary, the data transmission apparatus obtains an RTT with the data reception apparatus (operation S210). The RTT may be a pre-measured value or may be measured periodically. If the network environment is dynamic, it may be desirable to periodically measure and update the RTT to reflect the current network environment.

Next, the data transmission apparatus determines a maximum delay time Tₘₐₓ in consideration of characteristics of data (operation S220). The data transmission apparatus may determine a preset time value to be the maximum delay time in consideration of the characteristics of the data or may estimate the maximum delay time in consideration of the characteristics of the data based on a preset value.

The characteristics of the data may include the intensity of the real-time property of the data, the type of the data, the size of the data, and the like. However, even if data of the same kind are given, the maximum delay time may vary according to characteristics of a service. For example, in a voice call service such as VoIP, the maximum delay time of voice data may be determined to be about 100 milliseconds (ms). This is because a delay of more than 100 ms during a voice call can degrade voice quality. However, in the case of a voice mailbox service for transmitting voice data as a message, the transmission of voice data is performed in a similar form to the transmission of a file. Therefore, the real-time property becomes very weak. In this case, the maximum delay time may be determined to be a larger value.

The data transmission apparatus can estimate the maximum delay time based on a preset value in consideration of the size of data. Since the transmission delay increases as the size of data increases, data with a strong real-time property may be designed to be small-sized in order to reduce the transmission delay. For example, real-time control data for controlling a drone in a remote drone control service should be designed to be much smaller in size than voice data and video data because it has a strong real-time property. In this case, the maximum delay time of the real-time control data should be set to be smaller than a preset maximum delay time of the voice data. Therefore, even if there is no preset maximum delay time value of data, the data transmission apparatus can determine the maximum delay time value of the data based on a maximum delay time value of another data by considering characteristics such as data size.

The data transmission apparatus which has determined the maximum delay time compares the maximum delay time with the WIT (operation S230). When the RTT is smaller than the maximum delay time, the data transmission apparatus checks whether retransmission logic exists (operation S240). The retransmission logic denotes the ARQ-based retransmission logic as described above. If the retransmission logic exists, the data. transmission apparatus may determine that the time difference retransmission is not necessary and may reduce the network cost by entrusting a guarantee on the delay to the existing retransmission logic.

Even if the automatic retransmission logic exists, a transmission delay within the maximum delay time may not be guaranteed when a retransmission request packet of the data reception apparatus is lost. To prepare against the less of the retransmission request packet, the retransmission logic generally performs retransmission according to a retransmission timeout by using a retransmission timer. Here, since a transmission delay at the receiving end is approximately a retransmission timeout value, whether the time difference retransmission is necessary may be determined using the retransmission timeout value in order to more securely guarantee a transmission delay within a predetermined period of time.

Referring to FIG. 7B, when the maximum delay time is determined and the retransmission logic exists (operations S220 and S240), the data transmission apparatus obtains a timeout value T_{RTO} of the retransmission logic (operation S250) and compares the maximum delay time and the retransmission timeout value (operation S270). When determining that the maximum delay time is larger than the transmission timeout value, the data transmission apparatus may determine that the time difference retransmission is not necessary because the maximum delay time can be guaranteed even if the retransmission request packet of the data reception apparatus is lost.

The process of determining whether the time difference retransmission is necessary in FIG. 7B may be performed after the determination process in FIG. 7A. That is, after it is determined that the time difference retransmission is not necessary according to FIG. 7A, it may be determined whether the time difference retransmission is necessary according to FIG. 7B. However, since the retransmission timeout value is generally larger than the RTT, it would be enough for the data transmission apparatus to perform only the determination process of FIG. 7B while omitting the determination process of FIG. 7A.

Until now, the data transmission method according to the embodiment has been described. In summary, in the data transmission method according to the embodiment, the data transmission apparatus determines whether time difference retransmission is necessary in advance, thereby reducing the computing cost required to select time difference retransmission target data, set a retransmission time interval of the time difference retransmission, and determine whether the retransmission is possible. In addition, the data transmission apparatus can reduce the network cost by using the existing retransmission logic when an RTT is smaller than a maximum delay time.

Next, a method of efficiently utilizing network bandwidth by selecting time difference retransmission target data will be described in detail.

### Method of Selecting Time Difference Retransmission Target Data

The data transmission apparatus may select time difference retransmission target data according to a preset rule (operation S300). The rule may be established in consideration of various factors such as the type and content of data, the characteristics of a service, and the available bandwidth of a network. For example, when data is selected according to the type of data, the data transmission apparatus may determine real-time data among the real-time data and non-real-time data to be the time difference retransmission target data and exclude the non-real-time data from the time difference retransmission target data. This is because the non-real-time data such as files and log data generally do not require immediate delivery.

The selecting of the time difference retransmission target data (operation S300) may include giving a priority to the time difference retransmission target data according to a preset rule. The giving of the priority to the time difference retransmission target data may be performed after or at the same time as the selecting of the time difference retransmission target data. In other words, a priority may be given only to selected time difference retransmission target data. Alternatively, after all data are prioritized, the time difference retransmission target data may be selected based on the priorities.

In a case where priorities are given to selected data, the data transmission apparatus may utilize the given priorities in various ways such as retransmitting data on a priority list in a time difference manner within a range allowed by available bandwidth. For example, the data transmission apparatus may give a highest priority to voice data, a next highest priority to video data, and a lowest priority to other data. These data may be sorted and stored by priority and by retransmission time interval in a data structure such as a multi-level priority queue. Then, when the time to perform retransmission arrives, the data may be retransmitted with a time difference within the range allowed by the allowable bandwidth, starting with the data of a highest priority queue.

Until now, the method of selecting the time difference retransmission target data (operation S300) has been described. In summary, the data selection method used in some embodiments may be performed in consideration of various factors such as the type and content of data and the characteristics of a service. In addition, the data transmission apparatus can maximize the retransmission efficiency versus bandwidth by selecting the time difference retransmission target data.

Next, a method of determining a retransmission time interval for time difference retransmission will be described with reference to FIGS. 8A and 8B.

### Method of Determining a Retransmission Time Interval

After selecting time difference retransmission target data, the data transmission apparatus determines a retransmission time interval according to characteristics of the time difference retransmission target data (operation S500). If the retransmission time interval is too short, it is difficult to avoid a packet loss section due to a burst error. If the retransmission time interval is too long, it is difficult to guarantee a transmission delay of a predetermined period of time or less. Therefore, the data transmission apparatus needs to set an appropriate retransmission time interval.

Referring to FIG. 8A, the data transmission apparatus may determine a maximum delay time according to characteristics of data and may set a retransmission time interval to a value smaller than or equal to the maximum delay time (operations S510 and S530). This is because more than a certain level of service quality can be guaranteed if data is delivered within the maximum delay time. Since the determining of the maximum delay time according to the characteristics of the data (operation S510) is the same as operation S220, operation S220 can be referenced for details of operation S510.

If the data is real-time data, the retransmission time interval may be updated by further considering a jitter buffer value of the data reception apparatus as illustrated in FIG. 8B. This is because even if the real-time data avoids a packet loss section of the network through time difference retransmission, if the data is not received in a jitter buffer of the data reception apparatus, a retransmitted packet can be dropped at the receiving end.

In the present specification, the jitter buffer refers to a buffer used at the receiving end to remove jitter of packets received within a buffer size and to guarantee the real-time property, and jitter refers to a variable transmission delay phenomenon of data. Jitter can be caused by various factors such as queuing of network equipment, packet re-routing, and network multiplexing. Since jitter is a factor that deteriorates the quality of real-time service, the data reception apparatus which generally receives real-time data uses the jitter buffer to maintain the quality of service.

The jitter buffer value denotes the size of the jitter buffer and can be set in ms. If the size of the jitter buffer is set too large or too small, problems can occur. If the size of the jitter buffer is too small, the buffer may become full, causing packet loss. Conversely, if the size of the jitter buffer is too large, the packet loss may be reduced, but a delay may increase because packets stay longer in the buffer. In particular, in case of an interactive service (such as a video call) in which real-time data is exchanged, if the size of the jitter buffer is increased to reduce the packet loss, the quality of service may be deteriorated due to a bidirectional delay. Therefore, the size of the jitter buffer should be set in consideration of both the packet loss and the delay.

The jitter buffer value may be a value fixed according to a service executed in the data reception apparatus or a value varying flexibly according to the network conditions.

Referring to FIG. 8B, in the process of updating the retransmission time interval using the jitter buffer value, the data transmission apparatus may obtain a jitter buffer value Tⱼᵢₜₜₑᵣ of the data reception apparatus to update the retransmission time interval (operation S550). If the jitter buffer of the data reception apparatus is an adaptive or variable jitter buffer that varies according to network conditions, the data transmission apparatus may periodically obtain the jitter buffer value.

After obtaining the jitter buffer value, the data transmission apparatus compares the retransmission time interval with the jitter buffer value (operation S570). If the jitter buffer value is smaller than the retransmission time interval, the retransmission time interval may be updated to the jitter buffer value (operation S590). That is, it is possible to avoid a packet loss section of the network and prevent a packet drop at the receiving end by adjusting the retransmission time interval, thereby increasing a success rate of the time difference retransmission.

Conversely, the data reception apparatus can change the jitter buffer value based on the retransmission time interval determined by the data transmission apparatus. In this case, the data transmission apparatus may skip the process of updating the retransmission time interval illustrated in FIG. 8B. However, this is only a difference in the implementation method of the system.

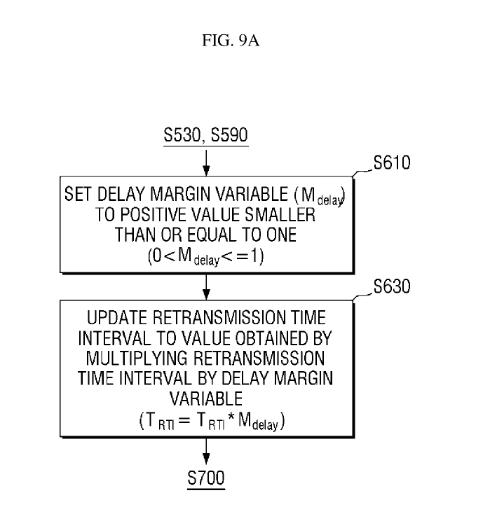

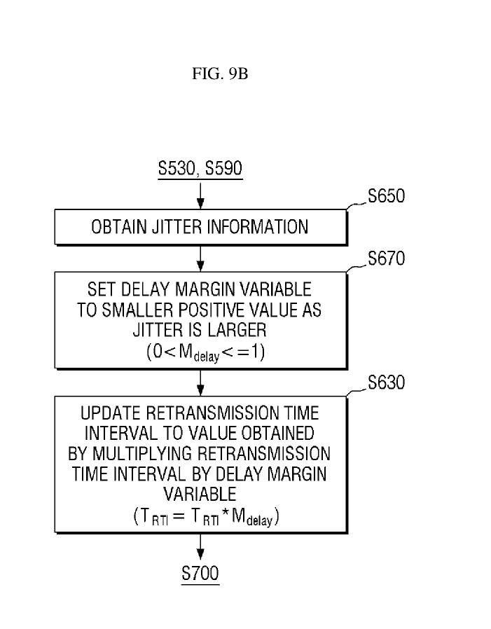

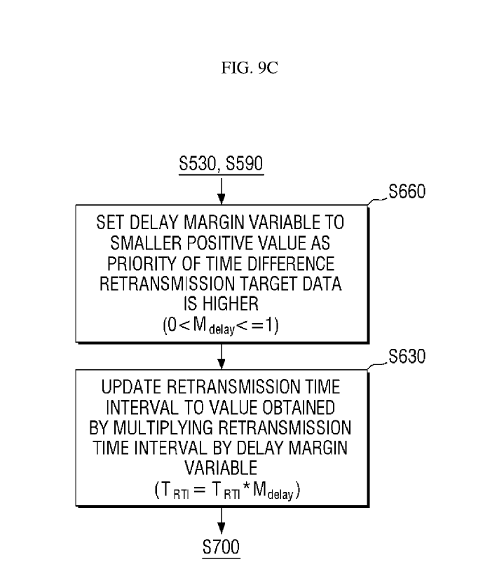

Since jitter can occur frequently depending on network conditions, data retransmitted with a time difference can be delayed to arrive at the data reception apparatus at a time later than expected. In this case, the time difference transmission target data may not be received in the jitter buffer of the data reception apparatus, or a transmission delay within a predetermined period of time may not be guaranteed even if the time difference transmission target data is received. Therefore, it may be necessary to secure a delay margin time to more securely guarantee delayed transmission in time. Hereinafter, a method of securing the delay margin time will be described with reference to FIGS. 9A through 9C.

Referring to FIG. 9A, the data transmission apparatus may set a value of a delay margin variable M_{delay} to secure a delay margin time (operation S610). The delay margin variable may have a value greater than zero and less than or equal to one. The data transmission apparatus may secure the delay margin time by updating a preset retransmission time interval to a value obtained by multiplying the preset retransmission time interval by the value of the delay margin variable (operation S630). Therefore, the value of the delay margin variable may be set to a smaller value to secure more delay margin time. Depending on the implementation method, it is also possible to secure the delay margin time by subtracting a desired delay margin time from the preset retransmission time interval instead of multiplying the value of the delay margin variable with the preset retransmission time interval. However, this is only a difference in implementation.

The data transmission apparatus may secure a different delay margin time based on the jitter of the data reception apparatus. This is because if the jitter value is large, there is a high probability that data will be delayed more than expected. Therefore, it is necessary to secure more delay time.

Referring to FIG. 9B, the data transmission apparatus obtains a jitter value of the data reception apparatus (operation S650). The data transmission apparatus may initially request or periodically obtain the jitter value measured by the data reception apparatus. Alternatively, the data transmission apparatus may periodically measure an RTT and obtain the jitter value by calculating the average of deviations of the RTT. Alternatively, the data transmission apparatus may obtain the jitter value by calculating the average of deviations of one-way delay time. Here, since paths in both directions between the data transmission apparatus and the data reception apparatus can be different and the bandwidths of the paths in both directions can be different, it may be better to obtain jitter information using the one-way delay time rather than the RTT.

Since transmission is more likely to be delayed as the jitter value is larger, the data transmission apparatus which has obtained the jitter information may secure more delay margin time by setting the delay margin variable to a smaller positive value (operations S670 and S630). In other words, the data transmission apparatus may update the retransmission time interval to a smaller value as the jitter value is larger.

The data transmission apparatus may secure a different delay margin time based on the priority of the time difference retransmission target data. According to a data transmission method of the inventive concept, even if the priority of the data is high, time difference retransmission may not be possible depending on the network state at the time of retransmission. In this case, the quality of service can deteriorate. Thus, according to a method illustrated in FIG. 10 which will be described later, the data transmission apparatus may perform the time difference retransmission again after a delay of a predetermined period of time. Therefore, if a different delay margin time is secured according to the priority of the time difference retransmission target data, more opportunities to retransmit the time difference retransmission target data through the delay of the time difference retransmission can be secured as the priority of the time difference retransmission target data is higher. Here, the priority of data may be given in the selecting of the time difference retransmission target data (operation S300), or a priority preset for each piece of data according to service may be given.

Referring to FIG. 9C, in a case where the priority of the time difference retransmission target data has been given according to a preset rule, the data transmission apparatus may set a delay margin variable to a smaller positive value when the priority of the time difference retransmission target data is higher in order to secure more delay margin time (operation S660). Then, the data transmission apparatus may secure the delay margin time by updating a preset retransmission time interval to a value obtained by multiplying the preset retransmission time interval by a value of the delay margin variable (operation S630). That is, the data transmission apparatus may update the retransmission time interval to a smaller value as the priority of the time difference retransmission target data is higher.

Until now, the method of determining the retransmission time interval of the time difference retransmission (operation S500) has been described. In summary, the data transmission apparatus can guarantee a transmission delay within a predetermined period of time by determining a retransmission time interval that can maximize the effect of avoiding a packet loss section and enables retransmitted data to be received in the jitter buffer. In addition, the data transmission apparatus can provide higher transmission reliability to higher priority data by securing a different delay margin time according to the priority of data.

Next, a method of determining whether time difference retransmission is possible at a time difference retransmission time will be described with reference to FIG. 10.

### Method of determining whether time difference retransmission is possible

When a Retransmission Time Interval Arrives the Data Transmission Apparatus determines whether time difference retransmission is possible based on the state of the network (operation S700). This is because, if the data transmission apparatus performs the time difference retransmission in a state where the network is congested, there is a possibility that retransmitted data will also be lost. In addition, data generated additionally for the time difference retransmission can increase the network congestion.

Referring to FIG. 10, the data transmission apparatus may utilize available bandwidth information B_{allow} of the network to sense the state of the network (operation S710). Depending on the implementation method, the data transmission apparatus may sense the state of the network by using a source quench message of the Internet control message protocol (ICMP) or by additionally considering the physical state of the network such as the link state of the network.

The data transmission apparatus may determine whether time difference retransmission is possible by checking whether an available bandwidth exists (operation S730). Alternatively, depending on the implementation method, if the available bandwidth is equal to or greater than a preset value, the data transmission apparatus may determine that the time difference retransmission is possible. When determining that the time difference retransmission is possible because the available bandwidth exists, the data transmission apparatus may determine the throughput of the time difference retransmission within the range of the available bandwidth based on a preset quality level of service (operation S750). That is, the data transmission apparatus may perform selective transmission according to the quality of service by controlling the throughput. For example, the data transmission apparatus may reduce the throughput to minimize the use of the bandwidth even if the quality of service is degraded. Conversely, the data transmission apparatus may increase the through to the allowable range of the available bandwidth in order to maximize the quality of service. To maximize the quality of service, the data transmission apparatus may perform retransmission several times at specific time intervals up to the allowable range of the available bandwidth.

In addition, the data transmission apparatus may model a transmission link as a stochastic process such as Poisson or Markov chain in order to determine the throughput. Thus, a model in which the throughput varies according to network conditions can be used. The data transmission apparatus can also determine the throughput in various other ways.

When determining that the time difference retransmission is not possible, the data transmission apparatus may additionally determine whether the time difference retransmission can be delayed (operation S740). For example, when the time difference retransmission target data is real-time data, the data transmission apparatus may determine that the time difference retransmission can be delayed within a range in which the real-time property of the real-time data is guaranteed. If the time difference retransmission target data is not the real-time data, the data transmission apparatus may determine whether the time difference retransmission can be delayed based on a preset number of time difference retransmissions or in other ways, which is only a difference in implementation.

In a case where the priority of the time difference retransmission target data has been set, the data transmission apparatus may allow the time difference retransmission to be delayed only when the priority of the time difference retransmission target data is equal to or higher than a predetermined priority. Conversely, when the priority of the time difference retransmission target data is lower than the predetermined priority, the data transmission apparatus may cancel the time difference retransmission without delaying the time difference retransmission.

When determining that the time difference retransmission can be delayed, the data transmission apparatus may update the retransmission time interval to a delayed time (operation S760). In the case of real-time data, the delayed time may be a value within a range in which the real-time property of the real-time data is guaranteed. In the case of non-real-time data, the delayed time may be a random value or a fixed value. In a case where the priority of the time difference retransmission target data has been set, the data transmission apparatus may set the delayed time of the time difference retransmission to a smaller time in order to give higher priority data more opportunities for time difference retransmission.

After the updated retransmission time interval elapses, the data transmission apparatus may determine again whether the time difference retransmission is possible (operation S700). When determining that the time difference retransmission is possible, the data transmission apparatus may perform the time difference retransmission (operation S900).

Until now, the method of determining whether time difference retransmission is possible at a time difference retransmission time (operation S700) has been described. In summary, the data transmission method according to the inventive concept minimizes network congestion by determining whether the time difference retransmission is possible based on the state of the network at the time difference retransmission time and, if the time difference retransmission is possible, provides customized retransmission according to the quality of service by adjusting throughput.

The concepts of the invention described above with reference to FIGS. 4 through 10 can be embodied as computer-readable code on a computer-readable medium. The computer-readable medium may be, for example, a removable recording medium (a CD, a DVD, a Blu-ray disc, a USB storage device, or a removable hard disc) or a fixed recording medium (a ROM, a RAM, or a computer-embedded hard disc). The computer program recorded on the computer-readable recording medium may be transmitted to another computing apparatus via a network such as the Internet and installed in the computing apparatus. Hence, the computer program can be used in the computing apparatus.

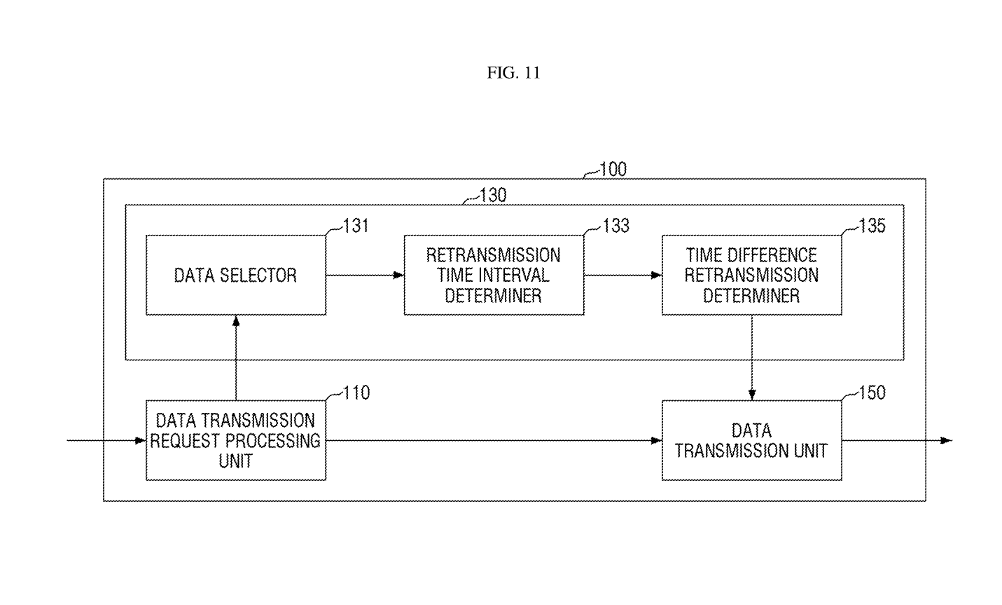

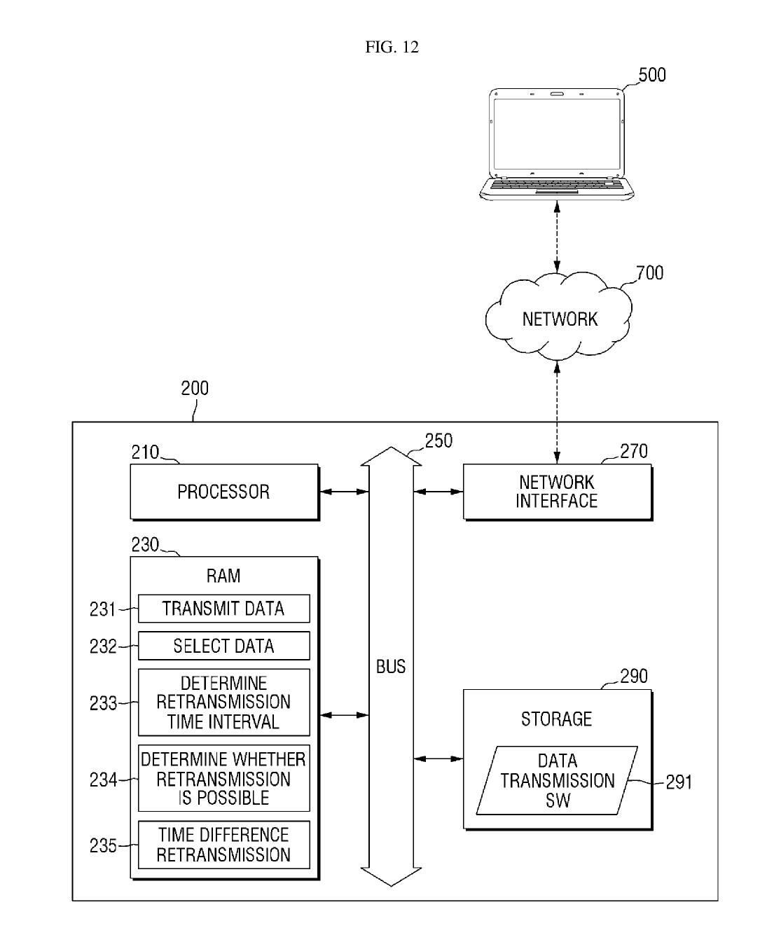

Next, the detailed configuration and operation of a data transmission apparatus according to an embodiment will be described with reference to FIGS. 11 and 12.

### Data Transmission Apparatus

FIG. 11 is a functional block diagram a data transmission apparatus 100 according to an embodiment.

Referring to FIG. 11, the data transmission apparatus 100 according to the inventive concept may include a data transmission request processing unit 110, a data transmission unit 150, and a time difference retransmission unit 130. The time difference retransmission unit 130 may include a data selector 131, a retransmission time interval determiner 133, and a time difference retransmission determiner 135. In FIG. 11, only the components related to the current embodiment are illustrated. Therefore, it will be understood by those of ordinary skill in the art to which the inventive concept pertains that other general-purpose components can further be included in addition to the components illustrated in FIG. 11.

Although not illustrated in FIG. 11, the data transmission apparatus 100 according to the inventive concept may further include a control unit and a communication unit. In addition, the control unit may include the data transmission request processing unit 110 and the time difference retransmission unit 130, and the communication unit may include the data transmission unit 150.

The communication unit may include a wired Internet module, a mobile communication module, or a wireless communication module for transmitting and receiving data to and from a data reception apparatus as described above.

The control unit controls the overall operation of each component of the data transmission apparatus 100. The control unit may include a central processing unit (CPU), a micro-processor unit (MPU), a micro-controller unit (MCU), or any type of processor well known in the art to which the inventive concept pertains. In addition, the control unit may perform an operation on at least one application or program for executing the methods according to the above-described embodiments.

As for the operation of each component, the data transmission request processing unit 110 receives a request for data transmission from an external module, such as an upper application, and sends input data to the data transmission unit 150 to request data transmission. In addition, the data transmission request processing unit 110 sends the same data to the time difference retransmission unit 130 to request time difference retransmission. The data may include real-time data that must be delivered to the data reception apparatus within a predetermined period of time.

The data selector 131 selects time difference retransmission target data by judging the input data according to a predetermined rule. Specifically, the data selector may select the time difference retransmission target data according to the above-described selection method.

The retransmission time interval determiner 133 determines a retransmission time interval according to characteristics of selected data. More specifically, the retransmission time interval determiner 133 may determine delay time according to the characteristics of the selected data and determine the maximum delay time to be the retransmission time interval. In addition, the retransmission time interval determiner 133 may update the retransmission time interval according to the above-described method.

The time difference retransmission determiner 135 may determine whether time difference retransmission is possible at a time difference retransmission time based on state information (such as available bandwidth) of a network. When determining that the time difference retransmission is possible, the time difference retransmission determiner 135 may set throughput according to the above-described method and request the data transmission unit 150 to perform transmission. Conversely, when determining that the time difference retransmission is impossible, the time difference retransmission determiner 135 may delay the time difference retransmission within a time range in which the transmission of the time difference retransmission target data is guaranteed and then determine again whether the time difference retransmission is possible at a delayed time. If the time difference retransmission target data has been given a priority, the delay of the time difference retransmission may be performed only for the time difference retransmission target data whose priority is equal to or higher than a predetermined priority.

In addition, the time difference retransmission determiner 135 may determine in advance whether the time difference retransmission is necessary in consideration of the maximum delay time, ARQ-based retransmission logic, and an RTT with the data reception apparatus as described above. Alternatively, the time difference retransmission determiner 135 may compare a retransmission timeout value with the maximum delay time as described above to determine in advance whether the time difference retransmission is necessary.

Lastly, the data transmission unit 150 may transmit data to the data reception apparatus through the network in response to a data transmission request and a time difference retransmission request. When the amount of data to be transmitted is determined, the data transmission unit 150 may transmit the determined amount of data.

Each component of FIG. 11 may be, but is not limited to, a software component or a hardware component such as a Field Programmable Gate Array (FPGA) or Application Specific Integrated Circuit (ASIC). The components may be configured to reside on a computer-readable storage medium and configured to execute on one or more processors. The functionality provided for in the components may be further separated into additional components or may be combined into fewer components.

FIG. 12 is a hardware block diagram of a data transmission apparatus 200 according to an embodiment.

Referring to FIG. 12, the data transmission apparatus 200 according to the current embodiment may include one or more processors 210, a network interface 270 which can exchange data with a data reception apparatus, a memory 230 which loads a computer program 291 to be executed by the processors 210, and a storage 290 which stores the computer program 291. In FIG. 12, only the components related to the current embodiment are illustrated. Therefore, it will be understood by those of ordinary skill in the art to which the inventive concept pertains that other general-purpose components can further be included in addition to the components illustrated in FIG. 12.

The computer program 291. may include an operation 231 of transmitting data to the data reception apparatus, an operation 232 of selecting time difference retransmission target data from the transmitted data according to a predetermined rule, an operation 233 of determining a retransmission time interval according to characteristics of the time difference retransmission target data, an operation 234 of determining whether time difference retransmission is possible based on the state of a network when the retransmission time interval arrives, and an operation 235 of retransmitting the time difference retransmission target data to the data reception apparatus if determining that the time difference retransmission is possible. However, the computer program 291 can further include operations that can be embodied as computer readable code in some of the above-described embodiments of the inventive concept.

The bus 250 serves as a data movement path to which the processors 210, the memory 230, the storage 290, and the network interface 270 described above are connected.

The network 700 may be implemented as any type of wired/wireless network, such as a local area network (LAN), a mobile radio communication network, a sensor network, or a satellite communication network.

The data transmission apparatus 200 may be any type of apparatus having communication functions and computing functions, such as a variety of IOT equipment including a notebook computer, a desktop computer, a laptop, a smart phone and a sensor.

Until now, the detailed configuration and operation of the data transmission apparatus according to the embodiment of the inventive concept have been described with reference to FIGS. 11 and 12. To facilitate the understanding of the inventive concept, an example of providing a video call system, which is one of real-time services, will be described by applying the inventive concept.

### Video Call System

As described above, a data transmission method and apparatus according to the inventive concept can guarantee a transmission delay within a predetermined period of time through time difference retransmission even in a network environment in which a packet loss section exists. Therefore, the inventive concept can be applied to a real-time system that requires a transmission delay within a predetermined period of time to maintain service quality. Hereinafter, a video call system according to an embodiment will be described. However, the inventive concept is applicable not only to a real-time multimedia system but also to an IoT-based system and apparatus such as low-power sensor equipment.

A video call system is a system providing a function that enables a plurality of users at remote places to overcome place constraints through a network and talk to each other while watching each other through the screen in real-time. The video call system may consist of a plurality of video call apparatuses that provide a video call function through the network, and a data transmission method according to the inventive concept may be applied to each video call apparatus.

A video call apparatus may transmit video data and voice data to a destination video call apparatus and perform time difference retransmission for avoiding a packet loss section. As described above, the video call apparatus may select time difference retransmission target data (operation S300), determine a retransmission time interval (operation S500), and determine whether the time difference retransmission is possible (operation S700) before performing the time difference retransmission.

The selecting of the time difference retransmission target data (operation S300) will first be described with reference to FIG. 13.

Since multimedia data such as video data and voice data is large in size, the network cost due to the time difference retransmission can be burdensome. Therefore, it is necessary to efficiently use the bandwidth of the network by selecting the time difference retransmission target data.

Referring to FIG. 13, a video call apparatus constituting the video call system may primarily select data according to the type of data. Of various types of data, the video call apparatus may identify voice data as data to be retransmitted with a time difference and exclude the other types of data from the retransmission target (operation S310). This is because users of the video call system are more sensitive to the loss of the voice data due to the characteristics of the video call system and because voice quality is an important criterion which determines the quality of the call.

The video call apparatus may also perform the data selection operation based on other criteria in order to utilize the bandwidth more efficiently. The video call apparatus may select a person's voice data only by excluding the surrounding noise data from the selected voice data (operation S330). In addition, the video call apparatus may select voice data having a signal intensity of a preset level or higher from the voice data without the noise data as the time difference retransmission target data (operation S350). This is because voice data whose signal intensity is below the preset level has an insignificant influence on call quality even if it is not retransmitted, considering a packet loss concealment (PLC) technique generally used in a destination video call apparatus.

The data selection method according to FIG. 13 is merely an example, and any other rules can also be applied. For example, the video call apparatus may not exclude video data from the time difference retransmission target and select the video data as a candidate group. Then, when the available bandwidth of the network is sufficient to not cause network congestion, the video call apparatus may perform time difference retransmission of the video data, thereby providing a higher quality of service.

When the time difference retransmission target data is selected, the video call apparatus may determine a retransmission time interval according to characteristics of the time difference retransmission target data (operation S500). When voice data is selected as the time difference retransmission target data according to the method illustrated in FIG. 13, the video call apparatus may determine a maximum delay time to be about 100 ms and set the maximum delay time as the retransmission time interval.

The video call apparatus may obtain a jitter buffer value of the destination video call apparatus, compare the retransmission time interval with the jitter buffer value, and update the retransmission time interval to the jitter buffer value when the jitter buffer value is smaller than the retransmission time interval. In addition, the video call apparatus may secure a delay margin time in order to guarantee a transmission delay time more stably. Specifically, the video call apparatus may update the retransmission time interval to a smaller value in order to secure more delay margin time as the jitter of a data reception apparatus is larger.

When the time to perform time difference retransmission arrives after the retransmission time interval, the video call apparatus may determine whether the time difference retransmission is possible before performing the time difference retransmission (operation S700). This is to prevent congestion in the existing network because voice or video data transmitted additionally due to the time difference retransmission is large in size. The video call apparatus may determine whether the time difference retransmission is possible based on the state of the network such as the available bandwidth at a time difference retransmission time.

When determining that the time difference retransmission is possible due to the existence of the available bandwidth, the video call apparatus may determine the throughput of the time difference retransmission based on the quality of service preset within the range of the available bandwidth. That is, the video call apparatus can adjust the throughput to minimize the use of the bandwidth even if the service quality is degraded or, conversely, increase the throughput to the allowable range of the available bandwidth to maximize the quality of service.

If there is no available bandwidth, the video call apparatus may delay the time difference retransmission within the range of the maximum delay time of the time difference retransmission target data. For example, if the time difference retransmission target data is voice data, the time difference retransmission can be delayed within a range of about 100 ms, which is the maximum delay time, from the transmission time of original data.

If the priority of the time difference retransmission target data has been set, the video call apparatus may delay the time difference retransmission only when the priority of the time difference retransmission target data is equal to or higher than a preset priority. For example, the video call apparatus may give a high priority to voice data for an emergency call, so that only the time difference retransmission of the voice data for the emergency call can be delayed. In addition, the video call apparatus may secure more delay margin time in the operation of setting the retransmission time interval when the priority of the time difference retransmission target data is high.

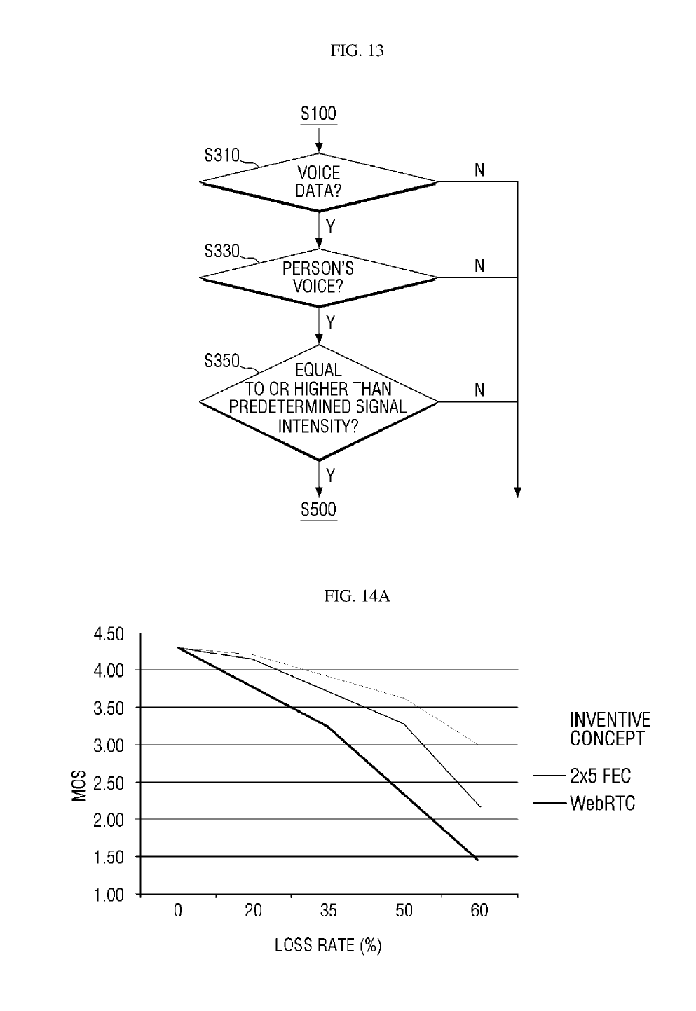

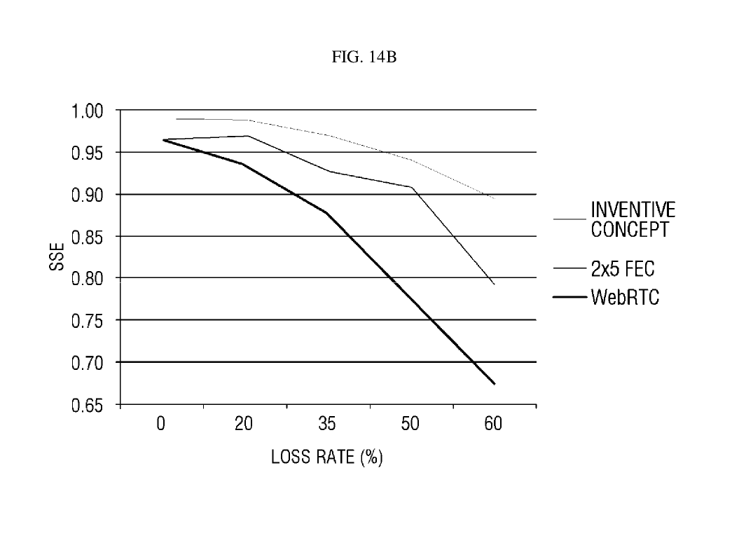

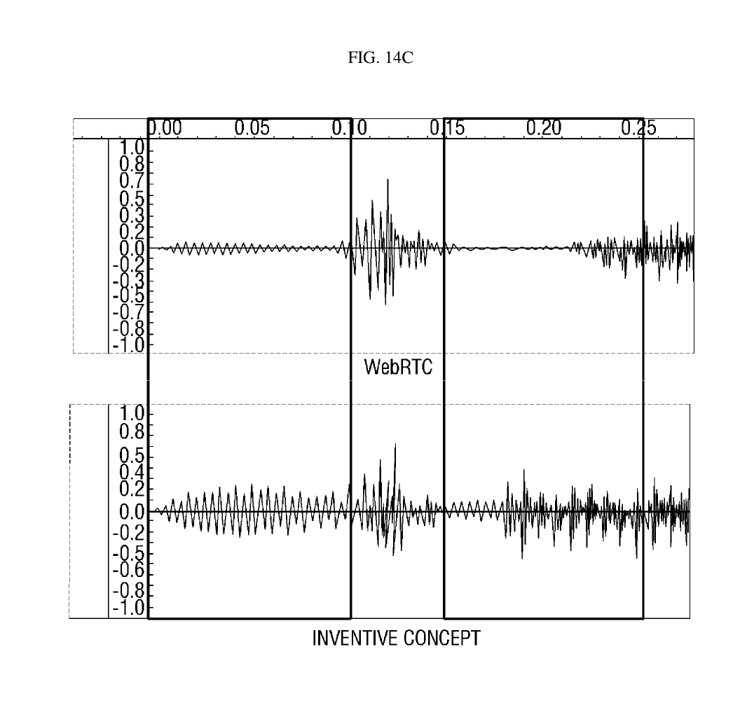

Until now, the video call system according to the embodiment has been described. Hereinafter, the results of comparative experiments on a video call system according to the inventive concept and a conventional video call system will be described in detail with reference to FIGS. 14A through 14C.

### Comparative Experiment Results

FIG. 14A illustrates the results of measuring a mean opinion score (MOS) according to a packet loss rate

A MOS, which is one of the comparison metrics according to the current experiment, is a score obtained by dividing subjective voice quality of a voice call into five levels. The MOS can be measured in such a way that a person's voice signal or a processed sampled voice signal is heard directly to an evaluator via a handset. A MOS of 3.0 or less denotes a quality that is hard to understand.

A packet loss rate refers to a ratio of packets lost during transmission to a total number of packets, and packet loss includes not only random packet loss but also burst packet loss.

In order to clearly show the effect of the inventive concept in the current experiment, the experiment was performed using a video call system utilizing a web real-time communication (WebRTC) of Google and a video call system utilizing the FEC technique as a control group among existing video call systems.

Referring to FIG. 14A, the horizontal axis of the graph represents the packet loss rate (%), and the vertical axis represents the MOS measurement value. As apparent from the graph, the MOS value of the video call system to which the inventive concept is applied is higher than those of the video call systems to which the WebRTC and the FEC method are applied. That is, it can be seen that the video call system according to the inventive concept provides the best voice quality on a subjective basis. In detail, in a case where the packet loss rate is 35%, the MOS value of Google's WebRTC is about 3.2, whereas the MOS value of the video call system according to the inventive concept is about 4.0, which shows a quality improvement of about 20% or more. Also, even when the packet loss rate is 50%, the MOS value of e video call system according to the inventive concept is maintained at 3.5 or more. From this, it can be seen that the data transmission method according to the inventive concept has a remarkable effect of improving the quality of service and can guarantee more than a certain level of quality of service even in an environment with packet loss.

FIG. 14B illustrates the results of measuring siding sumset entropy (SSE) according to a packet loss rate.

SSE is a metric introduced to more accurately calculate the difference in voice level between original data of the transmitting side and received data by adding entropy values while moving through a certain window. Unlike the MOS, the SSE can be regarded as one of the metrics for measuring objective service quality, and an SSE value closer to 1 indicates that the received data is similar to the original data. That is, the closer the SSE value is to 1, the higher the service quality.

Referring to FIG. 149, the horizontal axis of the graph represents the packet loss rate (%), and the vertical axis represents the SSE measurement value. As apparent from the graph, the objective quality of service of each video call system deteriorates as the packet loss rate increases. However, it can be seen that the deterioration of the quality of service is much smaller in the video call system according to the inventive concept than the other video call systems. In particular, Google's WebRTC shows a dramatic drop in service quality as the packet loss rate increases. That is, the data transmission method according to the inventive concept has an effect of improving the objective quality of service.

Lastly, FIG. 14C illustrates a speech waveform at the receiving end of the video call system according to the inventive concept and a speech waveform at the receiving end of the WebRTC of Google when the packet loss rate is 35%.

Referring to FIG. 14C, the horizontal axis of the graph represents the time axis, and the vertical axis represents the intensity of the speech waveform. Referring to the speech waveform at the receiving end of Google's WebRTC, the speech form includes two burst packet loss sections, each having a length of 100 ms. Even though data were not received due to the burst packet loss, a fine waveform was generated due to the PLC function and the reproduction control function of Google's WebRTC.

Referring to the speech waveform at the receiving end of the video call system according to the inventive concept, the video call system according to the inventive concept does not show a burst packet loss section, and voice packets were normally received. This is because the data transmission method according to the inventive concept avoids a burst packet loss section through time difference retransmission. That is, the data transmission method according to the inventive concept is invulnerable to a burst packet error and can maintain more than a certain level of service quality even in a case where a large number of packets are lost.

According to the inventive concept, it is possible to guarantee a transmission delay time within a predetermined period of time by performing time difference retransmission for avoiding a packet loss section, thereby providing more than a certain level of service quality and improving real-time responsiveness of service.

In addition, it is possible to improve the transmission efficiency relative to the network cost by performing the time difference retransmission only for selected data.

Furthermore, since the time difference retransmission can be performed using the existing transmission logic at the transmitting end without requesting the receiving end for logic, excellent portability can be provided to the existing system.

However, the effects of the inventive concept are not restricted to the one set forth herein. The above and other effects of the inventive concept will become more apparent to one of daily skill in the art to which the inventive concept pertains by referencing the claims.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A data transmission method comprising:
transmitting data from a data transmission apparatus to a data reception apparatus;
selecting, by the data transmission apparatus, time difference retransmission target data from the data based on a preset rule;
determining, by the data transmission apparatus, a retransmission time interval based on characteristics of the time difference retransmission target data;
determining, by the data transmission apparatus, when the retransmission time interval arrives, whether time difference retransmission is possible based on a state of a network; and
retransmitting, by the data transmission apparatus, when determining that the time difference retransmission is possible, the time difference retransmission target data to the data reception apparatus.

2. The method of claim 1, further comprising determining whether the time difference retransmission of the data is necessary before the selecting of the time difference retransmission target data,
wherein the selecting the time difference retransmission target data, the determining of the retransmission time interval, the determining of whether the time difference retransmission is possible, and the retransmitting of the time difference retransmission target data are performed only when determining that the time difference retransmission of the data is necessary.

3. The method of claim 1, wherein the data comprises real-time data to be delivered to the data reception apparatus within a predetermined period of time.

4. The method of claim 2, wherein the determining whether the time difference retransmission of the data is necessary comprises:
obtaining a round trip time (RTT) with the data reception apparatus;
determining a maximum delay time according to characteristics of the data;
determining, when the RTT is smaller than the maximum delay time, whether logic for performing retransmission in response to a retransmission request exists; and
determining that the time difference retransmission of the data is not necessary when the logic exists.

5. The method of claim 2, wherein the determining whether the time difference retransmission of the data is necessary comprises:
determining a maximum delay time according to characteristics of the data;
determining whether logic for performing retransmission in response to a retransmission request exists;
obtaining, when the logic exists, a retransmission timeout value set in a retransmission function; and
determining, when the retransmission timeout value is smaller than the maximum delay time, that the time difference retransmission of the data is not necessary.

6. The method of claim 1, wherein the selecting the time difference retransmission target data comprises:
identifying voice data among the data;
excluding noise data from the identified voice data; and
selecting voice data having a signal intensity of a preset level or higher from the voice data without the noise data, as the time difference retransmission target data.

7. The method of claim 1, wherein the determining the retransmission time interval comprises:
determining a maximum delay time according to the characteristics of the time difference retransmission target data; and
setting the retransmission time interval to a value smaller than or equal to the maximum delay time.

8. The method of claim 7, wherein the determining the maximum delay time comprises determining the maximum delay time to be a smaller value as the time difference retransmission target data is smaller in size.

9. The method of claim 7, wherein the setting the retransmission time interval to the value smaller than or equal to the maximum delay time comprises:
obtaining a jitter buffer value of the data reception apparatus;
comparing the retransmission time interval with the jitter buffer value; and
updating, when the jitter buffer value is smaller than the retransmission time interval, the retransmission time interval to the jitter buffer value.

10. The method of claim 7, wherein the setting the retransmission time interval to the value smaller than or equal to the maximum delay time comprises:
obtaining jitter with the data reception apparatus; and
updating the retransmission time interval to a smaller value as the jitter is larger.

11. The method of claim 7, wherein
the selecting the time difference retransmission target data from the data comprises giving a priority to the selected time difference retransmission target data according to a preset rule, and
the setting the retransmission time interval to the value smaller than or equal to the maximum delay time comprises updating the retransmission time interval to a smaller value as the priority of the time difference retransmission target data is higher.

12. The method of claim 1, wherein the determining of whether the time difference retransmission is possible comprises:
obtaining available bandwidth information of the network;
delaying, when the available bandwidth does not exist, the time difference retransmission within a maximum delay time range of the time difference retransmission target data; and
determining whether the time difference retransmission is possible at a delayed time.

13. The method of claim 12, wherein the delaying the time difference retransmission within the maximum delay time range of the time difference retransmission target data comprises delaying the time difference retransmission when the priority of the time difference retransmission target data is equal to or higher than a preset priority.

14. The method of claim 12, wherein the delaying the time difference retransmission within the maximum delay time range of the time difference retransmission target data comprises cancelling the time difference retransmission when the priority of the time difference retransmission target data is lower than the preset priority.

15. A data transmission apparatus comprising:
one or more processors;
a network interface configured to transmit and receive data to and from a data reception apparatus;
a memory configured to load a computer program to be executed by the one or more processors; and
a storage configured to store instructions for performing a method comprising:
an operation of transmitting data to the data reception apparatus;
an operation of selecting time difference retransmission target data from the data according to a preset rule;
an operation of determining a retransmission time interval according to characteristics of the time difference retransmission target data;
an operation of determining, when the retransmission time interval arrives, whether time difference retransmission is possible based on a state of a network; and
an operation of retransmitting, when determining that the time difference retransmission is possible, the time difference retransmission target data to the data reception apparatus.

16. A non-transitory computer-readable medium containing instructions which, when executed by a computing device, cause the computing device to perform the operations of:
transmitting data to a data reception apparatus;
selecting time difference retransmission target data from the data according to a preset rule;
determining a retransmission time interval according to characteristics of the time difference retransmission target data;
determining, when the retransmission time interval arrives, whether time difference retransmission is possible based on the state of a network; and
retransmitting, when determining that the time difference retransmission is possible, the time difference retransmission target data to the data reception apparatus.
